(19) United States
(12) Patent Application Publication
(10) Pub. No.: US 2010/0218096 A1
(43) Pub. Date: Aug. 26, 2010

(54) AUDIO/VISUAL PROGRAM SELECTION DISAMBIGUATION

(76) Inventor: Keith D. Martin, Hopedale, MA (US)

Correspondence Address: Bose Corporation;c/o Donna Griffiths, The Mountain, MS 40, IP Legal - Patent Support, Framingham, MA, 01701, US

(21) Appl. No.: 12/393,487

(22) Filed: Feb. 26, 2009

(51) Int. Cl. G06F 3/048

(52) U.S. Cl. 715/716

(57) ABSTRACT

Apparatus and method to disambiguate an ambiguous keypress sequence representing a character string made up of concatenated fragments of words entered by a user on a reduced keyboard, in which each fragment is made up of at least the first character of a word of text associated with an audio/visual program selected by the user for being played, and in which the fragments are combined in the character string without delimiters between them.

### TECHNICAL FIELD

This disclosure relates to disambiguating input provided by a user on a reduced keypad to select an audio/visual program for being played.

### BACKGROUND

Part of enjoying the playing of an audio/visual program (e.g., a piece of music, a recorded lecture, a recorded live performance, a movie, a slideshow, family pictures, an episode of a television program, etc.) is the task of selecting the desired audio/visual program. Unfortunately, the majority of existing user interfaces employed by devices involved in the playing of audio/visual programs suffer from various drawbacks that make the task of effecting such a selection in to a cumbersome experience. Some user interfaces employing various manually-operable knobs or scrolling wheels have been tried, but have the drawback of often requiring a user to read through a lengthy of list of audio/visual programs that they do not desire to have played in order to find the desired one. Other user interfaces employ full-sized “qwerty” keyboards to allow text associated with the desired audio/visual program (e.g., a name, a title, etc.) to be entered by a user, but the considerable size of full-sized keyboards make them less than desirable for use in many settings.

### SUMMARY

Apparatus and method to disambiguate an ambiguous keypress sequence representing a character string made up of concatenated fragments of words entered by a user on a reduced keyboard, in which each fragment is made up of at least the first character of a word of text associated with an audio/visual program selected by the user for being played, and in which the fragments are combined in the character string without delimiters between them.

In one aspect, a method entails receiving an ambiguous keypress sequence representing a character string made up of concatenated fragments of words entered by a user on a reduced keyboard, in which each fragment comprises at least a first character of a word, in which each fragment begins with the first character of a word, and in which the fragments of the words are entered without spaces or other delimiters between the words; identifying a possible position in the ambiguous keypress sequence of a first word of a record of a plurality of records in which each record of the plurality of records is associated with an audio/visual program; and identifying a possible position in the ambiguous keypress sequence of a second word of the record.

Implementations may include, and are not limited to, one or more of the following features. The method may further entail calculating a record score associated with the record based on the possible positions of the first word and the second word, and one or more of: 1) displaying information associated with the record as a result of the record having the highest record score of all of the records of the plurality of records, 2) playing an audio/visual program associated with the record as a result of the record having the highest record score of all of the records of the plurality of records, and 3) adding a preference offset associated with the record to the record score. Receiving the ambiguous keypress sequence may further entail receiving the ambiguous keypress sequence from a remote device; and the remote device may be a remote control, a PDA or a cell phone. Identifying a possible position in the ambiguous keypress sequence of the first word may further entail matching a first character of the first word to a character that may be represented by a keypress of the ambiguous keypress sequence. Further, matching the first character to a character that may be represented by a keypress of the ambiguous keypress sequence may entail maintaining a first string of digits associated in the record with the first word in which each digit corresponds to a digit marked on a key on which each letter of the first word is also marked; treating the ambiguous keypress sequence as a second string of digits in which each digit corresponds to a digit marked on a key that was pressed during entry of the ambiguous keypress sequence; and comparing the first digit in the first string of digits with at least one digit in the second string of digits. Identifying a possible position in the ambiguous keypress sequence of the first word may occur after all keypresses of the ambiguous keypress sequence have been entered by the user, or may occur in response to the entry of the first keypress of the ambiguous keypress sequence has been made by the user.

In another aspect, an apparatus includes a processing device and a storage. Within the storage is a records data incorporating a plurality of records in which each record of the plurality of records is associated with an audio/visual program, and a sequence of instructions. When the sequence of instructions is executed by the processing device, the processing device is caused to: 1) receive an ambiguous keypress sequence representing a character string made up of concatenated fragments of words entered by a user on a reduced keyboard, in which each fragment comprises at least a first character of a word, in which each fragment begins with the first character of a word, and in which the fragments of the words are entered without spaces or other delimiters between the words; 2) identify a possible position in the ambiguous keypress sequence of a first word of a record of the plurality of records; and 3) identify a possible position in the ambiguous keypress sequence of a second word of the record.

Implementations may include, and are not limited to, one or more of the following features. The apparatus may further incorporate a display, and the processing device may be further caused to calculate a record score associated with the record based on the possible positions of the first word and the second word. Further, the processing device may also be caused to: display information associated with the record as a result of the record having the highest record score of all of the records of the plurality of records; play an audio/visual program associated with the record as a result of the user selecting the audio/visual program from the display; and/or play an audio/visual program associated with the record as a result of the record having the highest record score of all of the records of the plurality of records. The apparatus may further incorporate a communications interface, and the processing device may be further caused to operate the communications interface to receive the ambiguous keypress sequence from a remote device having a reduced keyboard by which the ambiguous keypress sequence is created from the entry of the character string by the user. The apparatus may further incorporate a reduced keyboard or a touchscreen display capable of displaying a reduced keyboard, wherein the ambiguous keypress sequence is created from the entry of the character string by the user by pressing the keys of either the real reduced keyboard or the reduced keyboard displayed on the touchscreen display. The apparatus may further incorporate a communications interface, wherein the processing device is further caused to operate the communications interface to request the plurality of records from a media server, and wherein the processing device is further caused to operate the communications interface to request a copy of an audio/visual program associated with the record from the media server or to request the media server to transmit a copy of an audio/visual program associated with the record from the media server to a media player.

### BRIEF DESCRIPTION OF THE DRAWINGS

FIG. 1 is a block diagram of an embodiment of a media system enabling the selection of an audio/visual program for playing.

FIG. 2 depicts an embodiment of a remote device having a reduced keyboard.

FIG. 3 is a block diagram of another embodiment of a media system enabling the selection of an audio/visual program for playing.

FIGS. 4a and 4b are block diagrams of possible architectures.

FIG. 5 is a flowchart of an embodiment of a disambiguation procedure specialized to identify a desired audio/visual program.

FIG. 6 depicts an example of using the embodiment of a disambiguation procedure of FIG. 5.

FIG. 7 depicts an example of a visual display of results of using the embodiment of a disambiguation procedure of FIG. 5.

FIG. 8 is a flowchart of another embodiment of a disambiguation procedure specialized to identify a desired audio/visual program.

### DETAILED DESCRIPTION

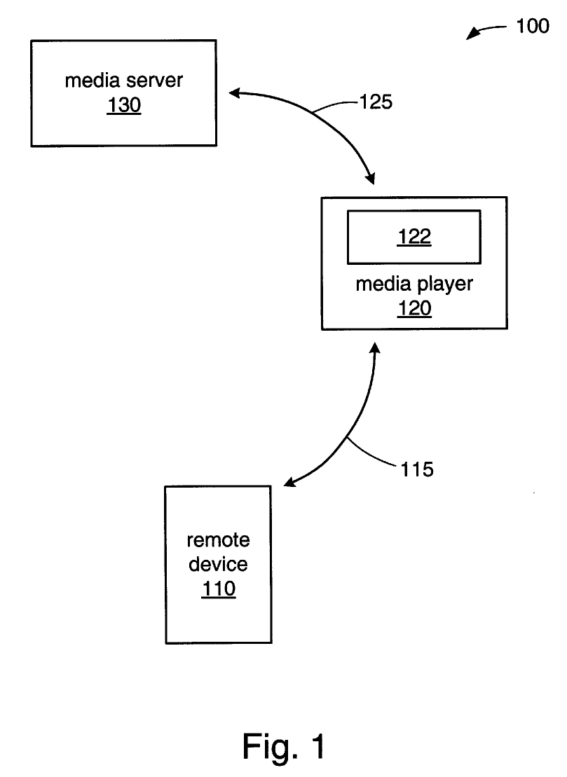

FIG. 1 is a block diagram of an embodiment of a media system 100 enabling the selection and playing of an audio/visual program (e.g., a piece of music, a recorded lecture, a recorded live performance, a movie, a slideshow, family pictures, an episode of a television program, etc.). The media system 100 incorporates a remote device 110 and a media player 120, and may further incorporate a media server 130. The remote device 110 communicates with the media player 120 through a communications link 115, and in turn, the media player 120 communicates with the media server 130 (if present) through a communications link 125. Each of the communications links 115 and 125 may be a wireless link employing radio frequency (RF), infrared (IR) or other wireless communications technology; and/or may employ cabling conveying electrical or optical signals. Where wireless RF technology is employed, any of a variety of radio frequencies or radio bands may be employed, including and not limited to frequencies within the industrial, scientific and medical (ISM) band allocated by the Federal Communications Commission (FCC). Further, where wireless RF technology is employed, any of a variety of communications protocols may be employed, including and not limited to, the various protocols promulgated by the Institute of Electrical and Electronics Engineers (IEEE), such as wireless networking protocols.

The remote device 110 is a remote control of a nature commonly employed in consumer audio/visual devices. The remote device 110 provides a keypad having at least some keys in an array that at least partly resembles a telephone keypad of a type commonly used by telephony devices in many places worldwide, wherein some of a plurality of the keys marked with one of the digits “0” through “9” are also marked with multiple ones of the letters “A” through “Z.” As will be explained in greater detail, the user employs these keys to enter concatenated fragments of text that are associated with a desired audio/visual program to select that audio/visual program to be played by the media player 120. Each of these fragments of text are the first letter or letters of a word associated with the desired audio/visual program, including and not limited to: names of composers, lecturers, authors, directors, singers, commentators, publishers, and/or presenters; titles of movies, songs, albums, speeches, television shows, and/or lectures; and classifications of audio/visual programs such as eras in history or genres. Such a keypad in which multiple characters (i.e., digits and/or letters) are marked on each of the numbered keys, instead of there being separate keys for each digit and letter as is the case with the keyboards having the widely known and used “qwerty” configuration, is commonly referred to as a “reduced keyboard.”

The smaller quantity of keys of a reduced keyboard has the advantage of allowing the overall size of a reduced keyboard to be smaller, thereby making a reduced keyboard advantageous for use in handheld portable devices, such as a remote control of a media system, a personal data assistant (PDA), or a cell phone. However, as is familiar to those skilled in the art of the design and use of reduced keyboards, the marking of keys with a digit and multiple letters makes the entry of each character of text via a reduced keyboard ambiguous. More specifically, the act of pressing a key of a reduced keyboard does not, by itself, provide a clear indication as to whether the user is entering the digit marked on that key or one of the letters marked on that key. As a result of the meaning of each of these keypresses being ambiguous, a procedure commonly referred to as “disambiguation” must be employed to determine which character of text marked on a key (i.e., the digit or one of the letters) is being entered with each keypress.

As a user operates the keys of the remote device 110, the remote device 110 transmits indications of which keys have been pressed to the media player 120 via the communications link 115. In some embodiments, the media player 120 receives these indications of keypresses, including the keypresses providing the user's indication of a selection of an audio/visual program, and performs a disambiguation procedure to identify the text entered by the user, and thereby identify the audio/visual program that the user desires be played. The media player 120 may be a “standalone” media player that, itself, stores audio/visual programs that the user may select to be played by the media player 120, and that is not in communication with any media server (i.e., not in communication with any other device storing audio/visual programs), including the media server 130. Examples of such “standalone” media players are variants of the 3-2-1® and Lifestyle® series of home theater systems available from Bose Corporation.

Alternatively and/or additionally to functioning as a standalone media player, the media player 120 may be in communication with the media server 130 via the communications link 125 to enable the media player 120 to receive digital data from the media server 130 that represents one or more audio/visual programs not stored by the media player 120. In embodiments in which the media player 120 performs disambiguation and where at least some of the audio/visual programs that may be selected may be stored within the media server 130, the media server 130 may provide the media player 120 with records data incorporating text associated with audio/visual programs stored within the media server 130 (e.g., names, titles, etc.). However, in other embodiments, the media server 130 may perform the disambiguation of the indications of keypresses received from the remote device 110, with the media player 120 passing on these indications of keypresses to the media server 130. In such embodiments where there are audio/visual programs also stored on the media player 120, the media player 120 may provide the media server 130 with records data incorporating text associated with audio/visual programs stored on the media player 120.

Where the media server 130 is located in the vicinity of the media player 120 (e.g., a computer system kept in the same home or business as the media player 120, and configured to function as a media server to the media player 120), the communications link 125 may be formed as part of a local area network (LAN). However, where the media server 130 is located at a distance (e.g., the media server 130 is operated as part of a paid service that provides access to audio/visual programs), the communications link 125 may be formed as part of a much larger network, including and not limited to, the Internet. Disambiguation of keypresses by the media server 130 may be more readily enabled where the media server 130 is located in the vicinity of the media player 120 such that the communications link 125 may exhibit lower latencies and/or higher reliability in the transmission of data. Where the media server 130 is located at a distance, it may be deemed more desirable for the media player 120 perform disambiguation.

The media player 120 may take any of a variety of possible physical forms that incorporates and/or is connectable to a video display (not shown) and/or speakers (not shown) to play an audio/visual program. In some embodiments, the media player 120 may be a dedicated consumer electronics device (e.g., an audio/visual receiver, television, pre-amplifier, etc.), such as one of the aforementioned examples of Bose Corporation products. In other embodiments, the media player 120 may be a general-purpose computer system having a processing device executing a sequence of instructions causing the processing device to operate other components of the general-purpose computer system to perform the function of a media player. Where the media player 120 is a standalone media player, the media player 120 may incorporate a hard drive, solid state memory, a magazine or carousel of optical discs kept in a disc changer, or other large capacity storage device in which a plurality of audio/visual programs are stored. Where the media player 120 is linked to the media server 130, the media player 120 may incorporate solid state memory to buffer the receipt of an audio/visual program received from the media server 130 in preparation for playing it, and may or may not store one or more audio/visual programs for playing at later times.

In some embodiments, the media player 120 may incorporate a visual display 122 to provide a user with visual feedback of results of the disambiguation of text entered by the user in selecting an audio/visual program. In other embodiments, the media player 120 may simply proceed with playing an audio/visual program that the media player 120 determines is most likely to be the audio/visual program that the user desires be played given the ambiguous input of the user. In some embodiments, where the media player 120 has incorrectly determined what audio/visual program the user desires be played, the user may be permitted to respond by continuing to enter more ambiguous text until the range of possible audio/visual programs having associated text that could correspond to what the user has entered is narrowed to the audio/visual program that the user wants. In other embodiments, such correction may be effected by the user being visually presented with a list of audio/visual programs having associated text that could correspond to what the user has entered so that the user may select the desired audio/visual program from that list by pressing one or more selection keys on the remote device 110.

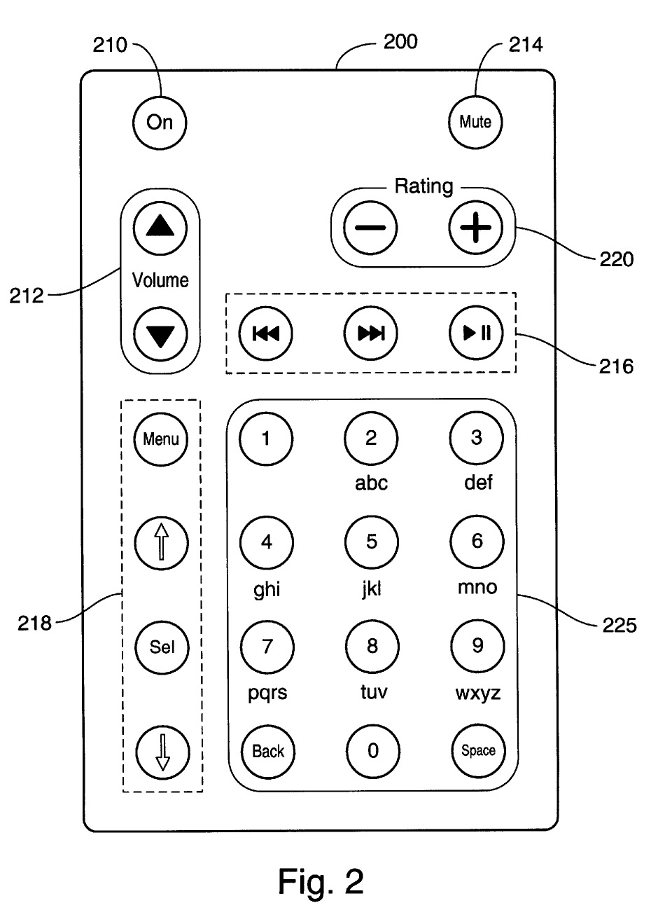

FIG. 2 depicts an embodiment of a remote device 200 that may be used as part of a media system, including in the media system 100 of FIG. 1 as the remote device 110. The remote device 200 incorporates a power on/off key 210, volume control keys 212, a mute key 214, play control keys 216, menu selection keys 218, audio/visual program rating keys 220, and a reduced keyboard 225. In some embodiments, the remote device 200 may further incorporate some form of visual indicator (not shown) to visually indicate some form of status or other information regarding a media player and/or media server with which the remote device 200 is in communication. By way of example, the remote device 200 may further incorporate a multicolor light-emitting diode (LED) that changes from emitting a red color to a green color as the possible result of disambiguation are narrowed and/or a text display displaying disambiguation results. In other embodiments, the remote device 200 may engage only in one-way communications in which the remote device 200 only transmits indications of keypresses via IR or other wireless technology to another device, such as the media player 120 of FIG. 1.

As previously discussed, a reduced keyboard, such as the reduced keyboard 225, may be used to enter characters of text in an ambiguous manner. By way of example, if a user wished to enter the letter “a” via the reduced keyboard 225, the user would press the “2” key with the result that it would be ambiguous as to whether the user meant to enter the “2” digit, the “a” letter, the “b” letter, or the “c” letter. By way of another example, if the user wished to enter the word “ball,” the user would use the keys of the reduced keyboard 225 to enter the digit sequence “2255.” Unfortunately, it would be ambiguous as to whether the user meant to enter the number “2255,” the word “ball,” the word “call,” or still some other combination of letters and/or digits.

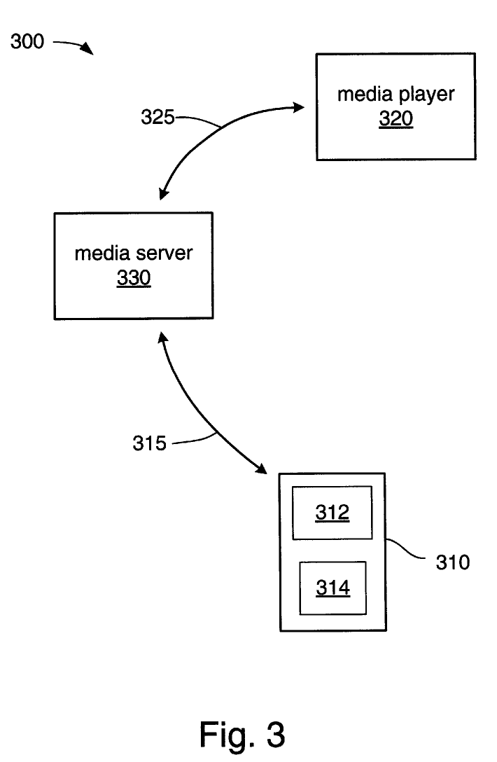

FIG. 3 is a block diagram of an embodiment of another media system 300 enabling the selection and playing of an audio/visual program. The media system 300 incorporates a remote device 310 and a media server 330, and may further incorporate a media player 320. The remote device 310 communicates with the media server 330 through a communications link 315, and in turn, the media server 330 communicates with the media player 320 (if present) through a communications link 325. Like the communications links 115 and 125 of the media system 100, the communications links 315 and 325 of the media system 300 may be based on any of a wide variety of technologies. Unlike the remote device 110 of FIG. 1, the remote device 310 of FIG. 3 incorporates both a visual display 312 and a reduced keyboard 314. Alternatively, the remote device 310 may incorporate a touchscreen display (not shown), and be capable of displaying the keys of a reduced keyboard on the touchscreen display to enable the ambiguous entry of text by a user. While the remote device 110 was a remote control having very limited functionality, the remote device 310 may be a personal data assistant (PDA), a cell phone, or other portable electronic device being capable of supporting a range of functions, including independently supporting two-way interaction with a user through the combination of the visual display 312 and the reduced keyboard 314 to enable the selection of an audio/visual program to be played.

In embodiments in which audio/visual programs are stored within the remote device 310, a processing device of the remote device 310 executes a sequence of instructions to cause disambiguation of the entry of text on the reduced keyboard 314 to be carried out by the remote device 310 in order to identify the audio/visual program that the user desires be played. Where the media player 320 is present and where an audio/visual program stored within the remote device 310 is selected, the remote device 310 may transmit the selected audio/visual program to the media server 330 and signal the media server 330 to retransmit the selected audio/visual program to the media player 320 to be played. Alternatively and/or additionally, the remote device 310 may be capable of directly playing the selected audio/visual program, itself, perhaps through a pair of headphones and/or the visual display 312.

In embodiments in which audio/visual programs are stored within the media server 330, either or both of the remote device 310 and the media server 330 may perform disambiguation. Where both the visual display 312 and the reduced keyboard 314 are employed to provide a user with two-way interaction in the disambiguation of the user's ambiguous text input to enable the user to select an audio/visual program, it may be deemed preferable for the remote device 310 to directly perform disambiguation to provide quicker responsiveness to each keypress made by the user than would be possible were keypresses transmitted to the media server 330 and disambiguation results received from the media server 330 through the communications link 315. It may also be deemed preferable for the remote device 310 to directly perform disambiguation where some audio/visual programs are stored on the remote device 310 in addition to other audio/visual programs being stored on the media server 330. In support of the remote device 310 performing disambiguation where at least some of the audio/visual programs that may be selected are not stored within the remote device 310, the media server 330 may provide the remote device 310 with records data incorporating text associated with audio/visual programs (e.g., names, titles, etc.). Where the media player 320 is present and where an audio/visual program stored on the media server 330 is selected, the remote device 310 may signal the media server 330 to transmit the selected audio/visual program to the media player 320 to be played. Alternatively and/or additionally, the remote device 310 may signal the media server 330 to transmit the selected audio/visual program to the remote device 310 for being played by the remote device 310, itself.

Where the media player 320 is located in the vicinity of the media server 330, the communications links 315 and 325 may be formed as part of a LAN. Indeed, some embodiments of the media system 300 may incorporate multiple ones of the media player 320 at different locations within a building, and the user may be provided with the ability to select which one of the multiple media players 320 will be employed in playing a selected audio/visual program. However, where the media server 330 is located at a distance, both the communications links 315 and 325 may be formed as part of a wide area network (WAN) or the Internet. Indeed, the media server 330 may be operated by a paid service that provides access to audio/visual programs, and which may transmit a selected audio/visual program to one or both of the remote device 310 and the media player 320 in response to receiving an indication of what audio/visual program is desired from the remote device 310.

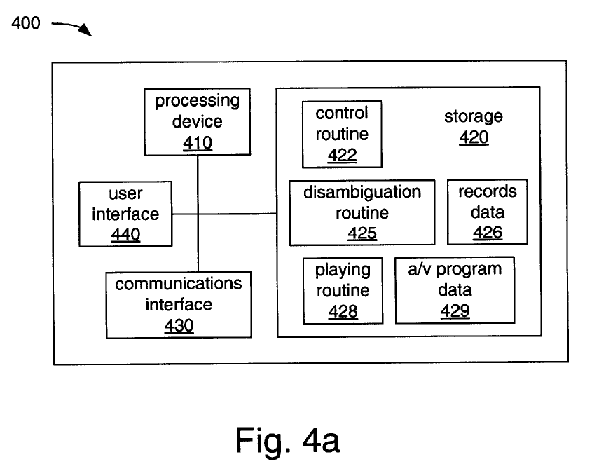

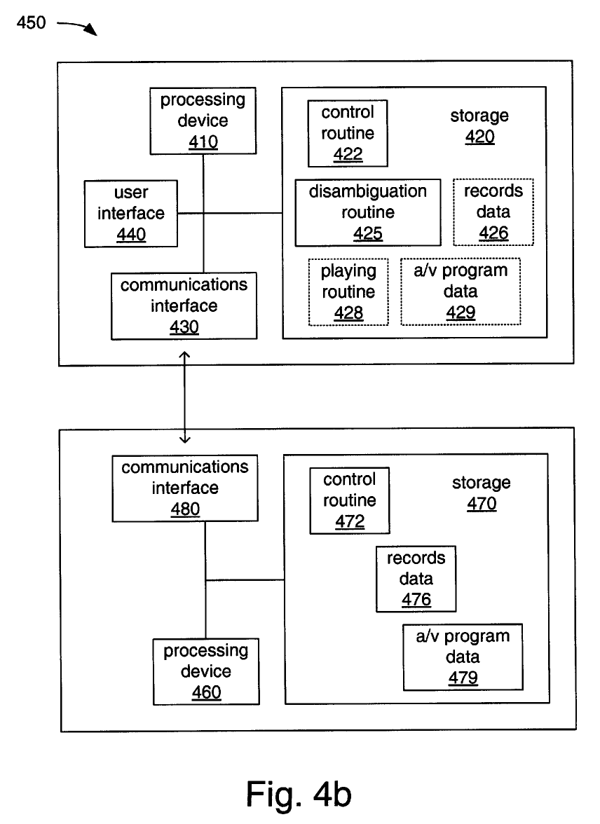

FIG. 4a is a block diagram of a possible architecture 400 for a device involved in the playing of an audio/visual program selected through user input requiring disambiguation. The architecture 400 may be employed by the media player 120 of FIG. 1, the remote device 310 of FIG. 3, or any other device performing both the disambiguation of user input and the playing of an audio/visual program selected with that input. A device employing the architecture 400 incorporates a processing device 410, a storage 420, a communications interface 430 and a user interface 440, all of which are interconnected through one or more buses to at least enable the processing device 410 to access the storage 420, the communications interface 430 and the user interface 440.

The processing device 410 may be any of a variety of types of processing device based on any of a variety of technologies, including and not limited to, a general purpose central processing unit (CPU), a digital signal processor (DSP), a microcontroller, or a sequencer. The storage 420 may be based on any of a variety of data storage technologies, including and not limited to, any of a wide variety of types of volatile and nonvolatile solid-state memory, magnetic media storage, and/or optical media storage. It should be noted that although the storage 420 is depicted as if it were a single storage device, the storage 420 may be made up of multiple storage devices, each of which may be based on different technologies. The communications interface 430 may employ any of a variety of technologies to enable a device employing the architecture 400 to communicate with another device, including and not limited to, wireless RF technologies, wireless optical technologies, and technologies employing electrically and/or optically conductive cabling. The user interface 440 may employ any of a variety of technologies to enable user interaction with a device employing the architecture 400, including and not limited to, a visual display, a reduced keyboard, or a touchscreen display capable of displaying a reduced keyboard and accepting user input therefrom. Where there is either a visual display or a touchscreen display, and/or where there is at least support for the attachment of speakers, such a display and/or such speakers may be utilized in playing a selected audio/visual program.

Stored within the storage 420 are one or more of a control routine 422, a disambiguation routine 425, records data 426, a playing routine 428, and audio/visual program data 429. Upon being executed by the processing device 410, a sequence of instructions of the control routine 422 causes the processing device 410 to coordinate both the disambiguation of user input on a reduced keyboard and the playing of an audio/visual program selected by a user through that input. In coordinating the disambiguation of user input, the processing device 410 may be caused by the control routine 422 to operate the user interface 440 to receive that input through either a reduced keyboard of the user interface 440 or a touchscreen presenting a reduced keyboard of the user interface 440. This may be the manner in which that input is received where, for example, the remote device 310 of FIG. 3 employs the architecture 400. Alternatively, the control routine 422 may cause the processing device 410 to operate the communications interface 430 to receive that input from another device with which the device employing the internal architecture 400 is in communication. This may be the manner in which that input is received where, for example, the media player 120 of FIG. 1 employs the architecture 400 to receive that input from the remote device 110 via the communications link 115.

Upon being executed by the processing device 410, a sequence of instructions of the disambiguation routine 425 causes the processing device 410 to disambiguate user input using the records data 426. The records data 426 is made up of a plurality of records, each of which is associated with an audio/visual program that may be selected by the user through their input for playing. Each record incorporates text data associated with an audio/visual program, including and not limited to: names of composers, lecturers, authors, directors, singers, commentators, publishers, and/or presenters; titles of movies, songs, albums, speeches, television shows, and/or lectures; and classifications of audio/visual programs such as eras in history or genres. As will be explained in greater detail, the disambiguation routine 425 employs the text of the records making up the records data 426 to identify an audio/visual program that the user has selected to be played.

Upon being executed by the processing device 410, a sequence of instructions of the playing routine 428 causes the processing device 410 to retrieve an audio/visual program from the audio/visual program data 429, and operate the user interface 440 to play it through speakers and/or a display of the user interface 440. The audio/visual program data 429 is made up of a plurality of audio/visual programs that may be selected by the user for playing. The playing routine 428 may incorporate further sequences of instructions that make up one or more audio and/or video decoding subroutines to aid in the playing of audio/visual programs that are stored as digital data having one or more various encoding formats (e.g., compressed audio or picture data, surround sound audio formats, alternate sound tracks, etc.).

In some embodiments, the control routine 422 may further operate the communications interface 430 to enable a user to retrieve additional audio/visual programs and text data for records associated with additional audio/visual programs from another device in order to add more audio/visual programs to the audio/visual program data 429 and their associated records to the records data 426.

FIG. 4b is a block diagram of another possible architecture 450. The architectures 400 and 450 have numerous substantial similarities, however, the architecture 450 is split across two devices in communication through a communications link in which at least disambiguation (and possibly also playing of audio/visual programs) is performed by a first device, while storage of audio/visual programs is performed (at least primarily) by a second device. The architecture 450 may be employed by the combination of the media player 120 and the media server 130 of FIG. 1 communicating through the communications link 125, the combination of the remote device 310 and the media server 330 of FIG. 3 communicating through the communications link 315, or any other pair of devices that cooperate to both disambiguate user input and play an audio/visual program selected by that input.

Not unlike a single device employing the architecture 400, the first device of a pair of devices employing the architecture 450 incorporates a processing device 410, a storage 420, a communications interface 430 and a user interface 440. Analogously, the second device incorporates a processing device 460, a storage 470, a communications interface 480, and possibly a user interface (not shown). Like the processing device 410, the storage 420 and the communications interface 430 of either of the first device or the one device employing the architecture 400 of FIG. 4a, the processing device 460, the storage 470 and the communications 480, respectively, of the second device may each be based on any of a variety of technologies.

What is stored in the storage 420 of the first device is substantially similar to what is stored in the storage 420 of the one device employing the architecture 400 of FIG. 4a. Also, the processing device 410 of the first device performs substantially the same functions. However, unlike the one device employing the architecture 400, the first device does not store audio/visual programs for playing (or at least, the storage of audio/visual programs is not its primary function). Instead, this function of storing audio/visual programs is primarily performed by the second device. Therefore, the records making up the records data 426 stored within the storage 420 in the first device must be provided to the first device by the second device to enable the first device to perform the disambiguation function. The processing device 410 may be caused by the control routine 422 to operate the communications interface 430 to retrieve these records from the second device on a recurring or other basis to support disambiguation by the first device.

Stored within the storage 470 of the second device are one or more of a control routine 472, records data 476, and audio/visual program data 479. Like the records data 426, the records data 476 is made up of a plurality of records, each of which is associated with an audio/visual program that may be selected by the user through their input for playing. Like the audio/visual program data 429, the audio/visual program data 479 is made up of a plurality of audio/visual programs that may be selected by the user for playing. Upon being executed by the processing device 460, a sequence of instructions of the control routine 472 causes the processing device 460 to support the disambiguation of user input by the first device by providing the first device with a copy of the records making up the records data 476. In doing so, the processing device 460 may be caused by the control routine 472 to operate the communications interface 480 to transmit those records to the first device.

Upon disambiguating a user's input sufficiently to identify a selected audio/visual program for playing, the processing device 410 may be caused by the control routine 422 to operate the communications interface 430 to request the second device to transmit a copy of the selected audio/visual program to the first device. The processing device 460 of the second device is caused by the control routine 472 to respond to this request by retrieving the selected audio/visual program from the audio/visual program data 479, and operating the communications interface 480 to transmit the selected audio/visual program to the first device. Upon receiving the selected audio/visual program, the processing device 410 may be further caused to store it in the storage 420 as the audio/visual program data 429. The processing device 410 may then be a caused by the playing routine 428 to play the selected audio/visual program via a display and/or speakers of the user interface 440.

Alternatively, upon disambiguating a user's input sufficiently to identify a selected audio/visual program for playing, the processing device 410 may be caused by the control routine 422 to operate the communications interface 430 to request the second device to transmit a copy of the selected audio/visual program to a third device (not shown) for playing. The processing device 460 of the second device is caused by the control routine 472 to respond to this request by retrieving the selected audio/visual program from the audio/visual program data 479, and operating the communications interface 480 to transmit the selected audio/visual program to the third device. This may be the manner in which the selected audio/visual program is played where the first device does not have the capability to play an audio/visual program (e.g., the playing routine 428 is not stored within the storage 420 and/or the user interface 440 is not able to support playing an audio/visual program), or where the user desires that the audio/visual program not be played by the first device.

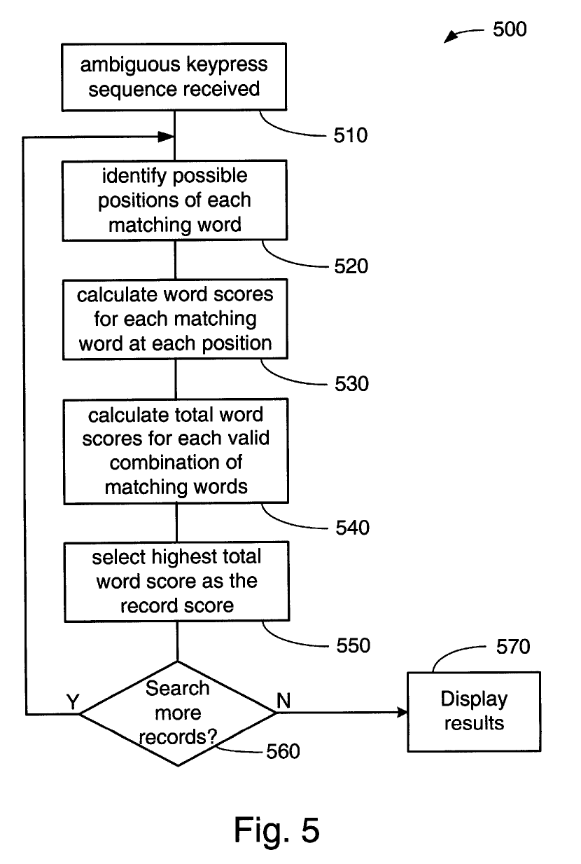

FIG. 5 is a flowchart of an embodiment of a disambiguation procedure specialized to identify a desired audio/visual program to be played from an ambiguous keypress sequence entered by a user on a reduced keyboard, such as the reduced keyboards discussed in relation to the media systems 100 and 300, and depicted in FIG. 2. A user presses keys of a reduced keyboard to enter text identifying an audio/visual program that the user desires be played, where each of these keys is each marked with a single digit and a plurality of letters in a manner that at least resembles a common telephony keypad. The user is able to select an audio/visual program with a minimum of keystrokes by entering a character string made up of two or more fragments of text from words associated with the desired audio/visual program. More specifically, the fragments are each the first one or more characters of a word taken from text associated with the desired audio/visual program (e.g., name, title, etc.), and the fragments are combined into a character string without spaces or other delimiters between the fragments (i.e., the fragments are concatenated to form the character string). By way of example, where the user desires to enter fragments of the two words making up the name of the musical group “Grateful Dead,” the user may enter “GRATDEA” (i.e., the first 4 characters of “Grateful” concatenated with the first 3 characters of “Dead”) or some other similar character string. It should be noted that one or more of the fragments may be made up of all of the characters of a word, which is likely where the word is relatively short. Therefore, the user may also enter “GRADEAD” (i.e., the first 3 characters of “Grateful” concatenated with all 4 characters of “Dead”) or “GDEAD” (i.e., the first character of “Grateful” concatenated with all 4 characters of “Dead”).

Although the user perceives the act of entering the text of a character string formed from concatenated text fragments as entering text having a meaning that is unambiguous to them, this act of the user becomes an entry of an ambiguous keypress sequence as a result of the ambiguous nature of the keys of the reduced keyboard. At 510, a device performing disambiguation to enable the selection of an audio/visual program receives the ambiguous keypress sequence, and begins matching words from text associated with each audio/visual program for which that device has a record to portions of the ambiguous keypress sequence. In some embodiments, the searching of the records may be terminated before all records have been searched for any of a variety of reasons, including and not limited to, a predetermined number of records being found that having matching words. In such embodiments, the records may be searched for matching words in any order, including and not limited to, in order of decreasing user preference of each audio/visual program, in order of most recent to least recent date on which each audio/visual program was last played, or in order of most recent to least recent date on which each audio/visual program was stored. Such information as a user preference score and/or most recent date of play may be maintained as part of the record of each audio/visual program. However, in other embodiments, all records are searched.

As records having matching words are found, the possible positions of each of the matching words within the ambiguous keypress sequence are identified at 520. At 530, word scores are calculated for each matching word based on the quantity of characters of each word that are found to match starting at each possible position within the ambiguous keypress sequence. These word scores are employed to calculate total word scores for each possible combination of the matching words of a record at 540, and at 550, the record is assigned the highest one of the total word scores as the record score for that record. At 560, if all the records have been searched or if other criteria for terminating the search for records having matching words is satisfied, then a list of the audio/visual programs that were each identified in this way as possibly being the audio/visual program desired by the user is displayed at 570. The audio/visual programs may be displayed in decreasing order of the record scores assigned to their records. Alternatively and/or additionally, the audio/visual program having the record assigned the highest record score may automatically begin to be played, and the user may employ a remote device to provide a signal to skip to the next audio/visual program in the list if the one currently playing is not the desired audio/visual program.

In some embodiments the fact that each key is marked with a digit and a corresponding plurality of letters may be used as a tool to effect the matching of words within records to portions of the ambiguous keypress sequence. Each keypress of the ambiguous keypress sequence may be treated as if it were an unambiguous entry of the digit marked on the key that was pressed, thereby essentially converting the ambiguous keypress sequence into a string of digits corresponding to the digit markings on the keys that were pressed. Further, for each word of the text within each record, a corresponding string of digits made up of the digits that correspond to each letter marked on the keys of the reduced keyboard is maintained. Matching is then effected through comparisons of these strings of digits. By way of example, and referring to the markings on the keys of the reduced keyboard 225 of FIG. 2, an entry of “GRATDEA” by a user entering the music group name “Grateful Dead” is converted into the string of digits “4728332” where each digit corresponds to the letters marked on those keys. Further, for each of the words “GRATEFUL” and “DEAD” of the text of the name “Grateful Dead” in a record, the strings of digits “47283385” and “3323” are maintained in the record along with the words, themselves, to enable such comparisons.

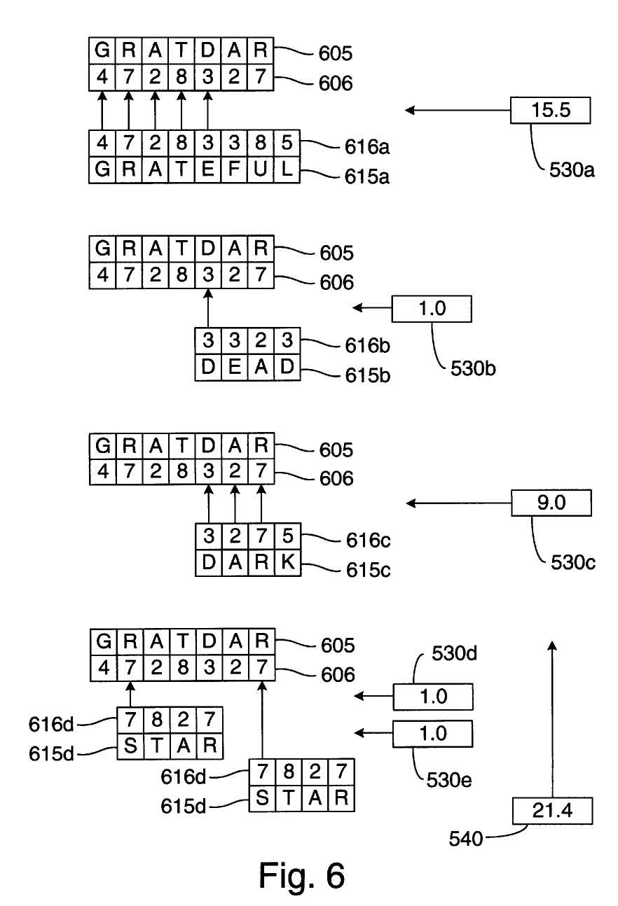

FIG. 6 is a diagram illustrating an example of the use of the embodiment of a disambiguation procedure depicted in FIG. 5. In the example shown in FIG. 6, the user desires to play the song “Dark Star” by the music group “Grateful Dead.” To do this, the user enters the “GRATDAR” character string 605 on a reduced keyboard, such as the reduced keyboard 225 of the remote device 200 of FIG. 2. Although the user perceives their own actions as entering an unambiguous character string made up of fragments of a word in the name of the music group (i.e., the first 4 characters of the word “GRATEFUL”) and a word in the title of the song (i.e., the first 3 characters of the word “DARK”), the ambiguous nature of the meaning of each keypress on a reduced keyboard results in an ambiguous keypress sequence. This ambiguous keypress sequence is treated as the “4728327” string of digits 606 in which each digit in this string corresponds to the digit marked on a key that was pressed in entering of this ambiguous keypress sequence.

At this point, it is important to remember that although FIG. 6 depicts the “GRATDAR” character string 605 that the user entered for the convenience of the reader, what exactly the user actually entered remains ambiguous to the device performing the disambiguation procedure 500, at least until the disambiguation procedure 500 is completed. The fact that each of the keys of the reduced keyboard used to enter the ambiguous keypress sequence is marked with only a single digit alongside the markings of multiple letters means that the digits are the only system of characters having a one-to-one correspondence with the keys, and therefore, are the only unambiguous meaning that could possibly be given to any of the keypresses. And, this is why the ambiguous keypress sequence resulting from the user's entry of the “GRATDAR” character string 605 is treated as the “4728327” string of digits 606 for purposes of performing disambiguation.

Among the records searched is a record corresponding to a performance of the song “Dark Star” by the music group “Grateful Dead” available for selection by the user as a playable audio/visual program. Maintained within this one record are the “GRATEFUL” word 615a, the “DEAD” word 615b, the “DARK” word 615c, and the “STAR” word 615d. Within this one record, strings of digits are maintained that each correspond to one of these words in the record, with each string of digits representing the digits marked on the keys of a reduced keyboard that would be pressed to enter the word to which it corresponds (the reader is invited to refer again to the markings on the keys of the reduced keyboard 225 in FIG. 2). Therefore, the “47283385” string of digits 616a, the “3323” string of digits 616b, the “3275” string of digits 616c, and the “7827” string of digits 616d are also maintained in this one record, and with the strings of digits 616a through 616d corresponding to the words 615a through 615d, respectively.

Records corresponding to audio/visual programs are searched with the strings of digits that correspond to words within each record being compared to the “4728327” string of digits 606 to locate records having matching words. For the sake of simplicity of discussion of this example, it will be assumed that the one record corresponding to the one performance of the song “Dark Star” by the “Grateful Dead” is the only record found to have matching words. In the process of determining that this one record has matching words, the possible positions of each of the words within the “4728327” string of digits 606 are determined. A word score is assigned to each matching word for each possible position that it may have within the string of digits 606. These word scores are each based on the quantity of characters of a given matching word are identified as possibly matching characters in the character string 605, and this is based on how many digits in the string of digits 605 are matched by digits of the string of digits associated with the given matching word starting at each possible position of the string of digits 605.

The “GRATEFUL” word 615a is identified as a possible matching word as a result of a possible position being identified starting at the first digit “4” of the “4728327” string of digits 606. This possible match and this possible position is identified as a result of a match being found between the first 5 digits in each of strings of digits 615a and 606. In some embodiments, the comparison of digits leading to this identification of a possible matching word and a possible position may be carried out one digit at a time. More specifically, the comparison may start with the first digit “4” of the string of digits 615a being compared against each digit of the string of digits 606, with only the first digit “4” in the string of digits 606 being found to be a match. With this match of single digits being found, the next digit “7” in the string of digits 616a is compared with the next digit “7” in the string of digits 606, and is found to also be a match. This digit by digit comparison continues until the sixth digit “3” in the string of digits 616a is compared to the sixth digit “2” in the string of digits 606, and is found to not be a match. As a result, the “GRATEFUL” word 615a corresponding to the string of digits 615a is found to be a possible match with up to the first 5 of its characters possibly being matching characters. It is important to emphasize that this is only a possible match of up to 5 characters, because as will be seen later in this example, this match will ultimately be determined to be based on less than all 5 of these characters.

A word score 530a is calculated and assigned to the “GRATEFUL” word 615a for its sole possible position starting at the first position of the “4728327” string of digits 606. Any of a variety of possible algorithms may be chosen that favor one or more characteristics of identified possible matching words over one or more other characteristics. The calculation employed in this example to calculate word scores is to multiply the quantity of possible matching characters of a matching word at a possible position (i.e., a quantity of 5, in this case) by the lesser of either the quantity of possible matching characters (i.e., 5, again) or the experimentally derived value of 3.1. This algorithm for calculating of word scores has been derived from experimentation. As a result of various tests, it has been found that greater accuracy in performing disambiguation to identify a desired audio/visual program is achieved if a calculation giving at least some weight to the quantity of possible matching characters in each possible matching word is used. Therefore, the fact that there are up to 5 possible matching characters in the “GRATEFUL” word 615a at the sole identified position is employed in this calculation. Also, tests of the use of disambiguation procedures solely for the specialized task of identifying audio/visual programs have been found to result in a limited enough range of possible combinations of matching words among the records of a typical-sized collection of audio/visual programs that it is often possible to successfully identify an audio/visual program from fragments of text that are each between 3 and 4 characters in length. Therefore, the experimentally derived multiplicative factor of 3.1 is employed in the calculation. Therefore, for the “GRATEFUL” word 615a at the identified position starting at the first digit of the “4728327” string of digits 606, the word score 530a of 15.5 (i.e., 5×3.1) is assigned. However, as those skilled in the art of deriving such a calculation will readily recognize, still other calculations to create word scores may be derived using heuristic and/or other approaches. Other examples of match score formulae include, but are not limited to, using the square of the quantity of matching characters, and using the square of the quantity of matching character minus the quantity of matching characters plus the value of 1.

The “DEAD” word 615b is determined to be a possible matching word as a result of a possible position being identified starting at the fifth digit “3” of the “4728327” string of digits 606. This possible match and possible position is identified as a result of a match being found between only the first digit in the string of digits 615b and the fifth digit in the string of digits 606. Therefore, the quantity of possible matching characters is only 1, which is less than the value 3.1, resulting in a word score 530b of 1.0 (i.e., 1×1) being assigned to the “DEAD” word 615b at this identified position.

The “DARK” word 615c is determined to be a possible matching word as a result of a possible position being identified as also starting at the fifth digit “3” of the “4728327” string of digits 606. This possible match and possible position is identified as a result of a match being found between the first 3 digits in the string of digits 615c and the fifth through seventh digits in the string of digits 606. Therefore, the quantity of possible matching characters is 3, which is less than the value 3.1, resulting in a word score 530c of 9.0 (i.e., 3×3) being assigned to the “DARK” word 615c at this identified position.

The “STAR” word 615d is determined to be a possible matching word with two possible positions being identified at second digit “7” and at the seventh digit “7” of the “4728327” string of digits 606. This possible match at two possible positions are identified as a result of a match being found between only the first digit in the string of digits 615d and both the second and seventh digits in the string of digits 606. Therefore, the quantity of possible matching characters at each possible position is only 1, which is less than the value 3.1, resulting in word scores 530d and 530e of 1.0 (i.e., 1×1) being assigned to the “STAR” word 615d at each of the positions identified at the second and seventh digits of the string of digits 606.

The number of possible combinations of the words 615a through 615d at their identified positions in the string of digits 606 is 24. For example, one possible combination is the word 615a starting at the first position, the word 615b starting at the fifth position, and the word 615d starting at the seventh position, with the word 615c not being used in this combination. However, in this combination, the “2” digit at the sixth position of the string of digits 606 remains unmatched, and therefore, this combination is not deemed to be valid. The fact that one of the digits of the string of digits 606 has not been matched means that the meaning of one of the keypresses in the ambiguous keypress sequence represented by the string of digits 606 has not been determined, and therefore, a disambiguation of that ambiguous keypress sequence has not been accomplished. Another possible combination is the word 615a starting at the first position and the word 615c starting at the fifth position, with neither of the words 615b and 615d being used. In this combination, every digit in the string of digits 606 is matched, and therefore, this combination is deemed valid.

For each valid combination, a total word score is calculated by adding together the word scores of each of the words 615a through 615d that are used and that correspond to the positions at which they are used. The aforedescribed combination of the word 615a starting at the first position and the word 615c starting at the fifth position has a total word score of 24.5 (i.e., the sum of the word scores 530a and 530c). In this example, an analysis of each of the 24 possible combinations reveals that this is the only combination found to result in every digit of the string of digits 606 being matched, and therefore, is the only combination deemed valid. However, were it the case that more than one of the possible combinations were found to be valid, whichever one of such combinations has the highest total word score would be selected as the most likely combination of the words 615a through 615d to correspond to the character string 605.

However, in some embodiments, the calculation of the total word score may be modified to account for instances where there is an overlap of the positions of the matching characters of two matching words. Since strings of digits corresponding to text characters are used in the comparisons that identify possible matching words, either of the fifth character “E” of the “GRATEFUL” word 615a and the first character “D” of the “DARK” word 615c could be deemed to be the matching character to be positioned at the fifth position in the string of digits 606. However, given that the “DARK” word 615c was identified as being positioned so as to start at the fifth position, the fifth position may be assigned to the word 615c, and the word score of the word 615a may be recalculated with its quantity of possible matching characters reduced from 5 to 4. As a result, the word score 530a for the word 615a starting at the first position would be reduced to 12.4 (i.e., 4×3.1), instead of the 15.5. Of course, such a recalculation of this word score reduces the total word score for the one possible combination of the words 615a through 615d that was deemed to be valid from 24.5 to an altered total word score 540 of 21.4 (i.e., the sum of the reduced word score 530a of 12.4 and the unchanged word score 530c of 9.0). Were there more than one combination of the words 615a through 615d deemed to be valid in this example, this change in this one total word score might alter which combination would be selected as the most likely combination to accurate identify the meaning of the ambiguous keypress sequence entered by the user.

As stated towards the beginning of this example, the one record corresponding to an audio/visual program of a performance of the song “Dark Star” by the “Grateful Dead” is assumed to be the only record found to have matching words for the sake of simplicity of discussion. However, were there more than one record found to have matching words, the highest total word scores derived for the words of each of those records may be used as their record scores, and the user may be presented with a list of audio/visual programs in descending order of the record scores of their associated records. The audio/visual program having the associated record with the highest record score would be deemed to most likely be the audio/visual program that the user desires be played.

However, in some embodiments, each record score may be the sum of the highest total word score and a preference offset for that record, instead of being simply the highest total word score. The preference offsets may reflect a bias of the user, such as a preference for a particular artist, genre, album, track, etc. Alternatively, other factors may be incorporated into the preference offsets, including and not limited to, the relative frequency with which each of the audio/visual programs are played, how long ago each of the audio/visual programs were last played, and/or the relative frequency with which the user chooses to skip or cancel the playing of each of the audio/visual programs.

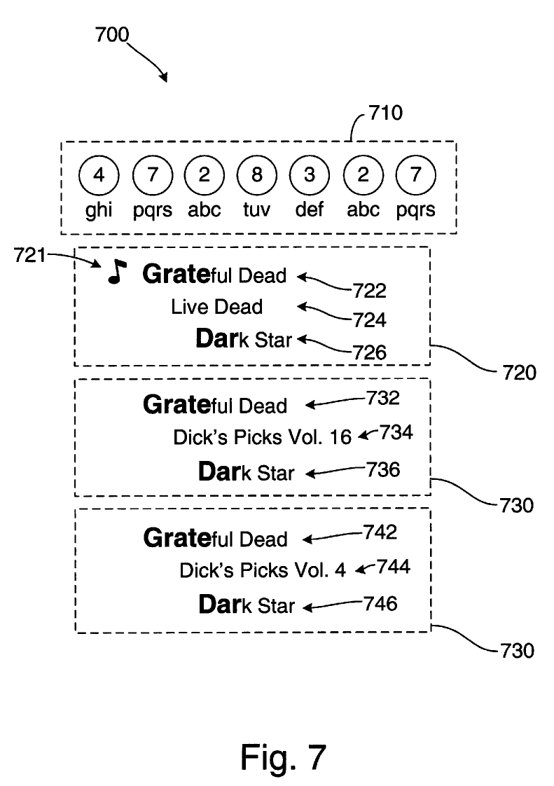

FIG. 7 depicts an example of a visual display of the possible results of the user attempting to select an audio/visual program of the music group “Grateful Dead” performing the song “Dark Star” for playing by entering the character string “GRATDAR” on a reduced keyboard, just as was the case in the example discussed in relation to FIG. 6. However, unlike the example discussed in relation to FIG. 6, in this example, more than one record has matching words for the user's input.

The ambiguous keypress sequence 710 resulting from the user entering the character string “GRATDAR” is displayed as a series of graphical icons depicting the digit and letters with which each pressed key is marked (the reader is invited to again refer to the depiction of the keys of the reduced keyboard 225 in FIG. 2 to view the key markings). One or more records 720, 730 and 740 found to have matching words are displayed adjacent the display of the ambiguous keypress sequence 710. As depicted, each of the records 720, 730, 740 displays an artist name 722, 732, 742; an album 724, 734, 744; and a track title 726, 736, 746. However, as will be readily recognized by those skilled in the art, other combinations of text from records associated with audio/visual programs may be displayed. Matching characters of the matching words of each of the records 720, 730 and 740 may be highlighted through the use of bolding, alternate text colors, alternate fonts, etc. An icon 721 may be displayed in a position adjacent to or within the display of the text of one of the records 720, 730 and 740 to indicate a type of media, to indicate whether the associated audio/visual program is an audio-only program or includes video, and/or to indicate which audio/visual program is currently being played. The records 720, 730 and 740 may be displayed in order of decreasing record score. Although, in this example, the records 720, 730, and 740 refer to the same artist and track title, and therefore might be expected to have identical record scores, those record scores may be caused to be different as a result of the adding of preference offsets to total word scores to arrive at the record scores. Therefore, the depicted order in which the records 720, 730 and 740 are displayed in FIG. 7 may reflect a preference of the user for playing the audio/visual program associated with the record 720 over either of the audio/visual programs associated with the records 730 and 740.

In some embodiments, this display of the results of a user attempting to select an audio/visual program for playing may be accompanied by the automatic playing of the audio/visual program associated with the record 720 without further prompting by the user. The user may choose to respond by pressing other keys or otherwise providing an indication to the effect that an audio/visual program associated with either of the records 730 or 740 is preferred. This allows the user to select the desired audio/visual program without having to look at the visual display of records depicted in FIG. 7. Indeed, other embodiments may provide no display of the ambiguous keypress sequence 710 or of the records 720, 730 and 740, as the playing of the audio/visual program associated with the record 720 is simply started and continues until the user indicates that this is not the desired audio/visual program.

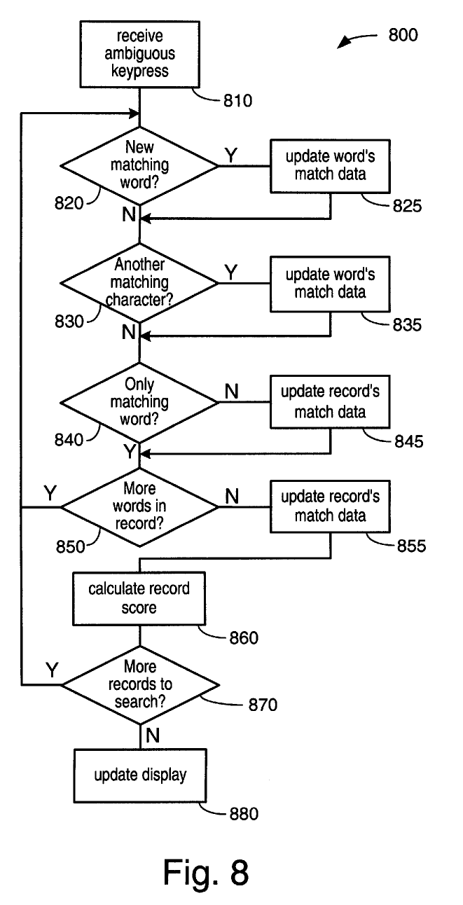

FIG. 8 is a flowchart of another embodiment of a disambiguation procedure 800 specialized to identify a desired audio/visual program to be played from an ambiguous keypress sequence entered by a user on a reduced keyboard, such as the reduced keyboards discussed in relation to the media systems 100 and 300, and the reduced keyboard 225 depicted in FIG. 2. Unlike the disambiguation procedure 500 of FIG. 5, where the entire ambiguous keypress sequence is entered prior to a search being made for records having matching words, in the disambiguation procedure 800 of FIG. 8, an incremental search for records having matching words is performed as each keypress of the ambiguous keypress sequence is made by the user. More specifically, FIG. 8 depicts how the receipt of each ambiguous keypress is responded to.

At 810, an ambiguous keypress of an ongoing entry of an ambiguous keypress sequence is received.

At 820, a determination is made as to whether a word of the text of a record may be a new matching word (either through the comparing of strings of digits, as previously described, or through another mechanism) at the position of the just-received ambiguous keypress in the ambiguous keypress sequence. If so, then match data associated with that word is updated to identify the position(s) at which the word may be a new matching word at 825.

Next, a determination is made at 830 as to whether or not the receipt of the ambiguous keypress has resulted in the word possibly having another matching character. If so, then the match data associated with that word is updated to increment the quantity of possible matching characters in that word at 835.

Next, a determination is made at 840 as to whether or not the word is the only word in the text of the record that is able to be matched to the just-received ambiguous keypress, either a new word starting at the position of the just-received ambiguous keypress (as determined at 820), or as a result of the word having another matching character at the position of the just-received ambiguous keypress (as determined at 830). If so, then the matching data associated with the record is updated to assign that word, and only that word, to that position in the ambiguous keypress sequence in which that word is matched to the just-received ambiguous keypress, and any match data associated with the record indicating any other possible position of that word in the character string is discarded at 845.

At 850, the disambiguation procedure 800 returns to 820 to repeat the same determinations made at 820, 830 and 840 with another word of the same record if there are more words in the same record. Otherwise, the disambiguation procedure 800 proceeds to 855 where the match data of the record is updated to reflect any changes to the list of possible combinations of words for that record, and their associated total word scores. At 860, the record score for that record is calculated from the highest word score. In some embodiments, the calculation of the record score may entail the addition of a preference offset value, as previously described.

At 870, the disambiguation procedure returns to 820 to repeat the same determinations made at 820, 830 and 840 with a word of another record if there are more records to be searched. Otherwise, the disambiguation procedure 800 proceeds to 880 where a visual display of a list of audio/visual programs in descending order of the record scores of their associated records is updated to take into account any change in record scores.

Although various embodiments have been depicted and/or discussed in detail herein, this has been done to facilitate understanding through the presentation of examples and should not be taken as limiting the scope of the claims that follow.

1. A method comprising:
receiving an ambiguous keypress sequence representing a character string comprised of concatenated fragments of words entered by a user on a reduced keyboard, in which each fragment comprises at least a first character of a word, in which each fragment begins with the first character of a word, and in which the fragments of the words are entered without spaces or other delimiters between the words;
identifying a possible position in the ambiguous keypress sequence of a first word of a record of a plurality of records in which each record of the plurality of records is associated with an audio/visual program; and
identifying a possible position in the ambiguous keypress sequence of a second word of the record.

2. The method of claim 1 further comprising:
calculating a record score associated with the record based on the possible positions of the first word and the second word; and
displaying information associated with the record as a result of the record having the highest record score of all of the records of the plurality of records.

3. The method of claim 1 further comprising:
calculating a record score associated with the record based on the possible positions of the first word and the second word; and
playing an audio/visual program associated with the record as a result of the record having the highest record score of all of the records of the plurality of records.

4. The method of claim 1 further comprising:
calculating a record score associated with the record based on the possible positions of the first word and the second word; and
adding a preference offset associated with the record to the record score.

5. The method of claim 1 wherein receiving the ambiguous keypress sequence further comprises receiving the ambiguous keypress sequence from a remote device.

6. The method of claim 5 wherein the remote device is one of a group of possible remote devices consisting of a remote control, a PDA and a cell phone.

7. The method of claim 1 wherein identifying a possible position in the ambiguous keypress sequence of the first word further comprises matching a first character of the first word to a character that may be represented by a keypress of the ambiguous keypress sequence.

8. The method of claim 7 wherein matching the first character to a character that may be represented by a keypress of the ambiguous keypress sequence comprises:
maintaining a first string of digits associated in the record with the first word in which each digit corresponds to a digit marked on a key on which each letter of the first word is also marked;
treating the ambiguous keypress sequence as a second string of digits in which each digit corresponds to a digit marked on a key that was pressed during entry of the ambiguous keypress sequence; and
comparing the first digit in the first string of digits with at least one digit in the second string of digits.

9. The method of claim 1 wherein identifying a possible position in the ambiguous keypress sequence of the first word occurs after all keypresses of the ambiguous keypress sequence have been entered by the user.

10. The method of claim 1 wherein identifying a possible position in the ambiguous keypress sequence of the first word occurs in response to the entry of the first keypress of the ambiguous keypress sequence has been made by the user.

11. An apparatus comprising:
a processing device; and
a storage storing a records data comprising a plurality of records in which each record of the plurality of records is associated with an audio/visual program, and storing a sequence of instructions that when executed by the processing device, causes the processing device to:
receive an ambiguous keypress sequence representing a character string comprised of concatenated fragments of words entered by a user on a reduced keyboard, in which each fragment comprises at least a first character of a word, in which each fragment begins with the first character of a word, and in which the fragments of the words are entered without spaces or other delimiters between the words;
identify a possible position in the ambiguous keypress sequence of a first word of a record of the plurality of records; and
identify a possible position in the ambiguous keypress sequence of a second word of the record.

12. The apparatus of claim 11 further comprising a display, and wherein the processing device is further caused to:
calculate a record score associated with the record based on the possible positions of the first word and the second word; and
display information associated with the record as a result of the record having the highest record score of all of the records of the plurality of records.

13. The apparatus of claim 12, wherein the processing device is further caused to play an audio/visual program associated with the record as a result of the user selecting the audio/visual program from the display.

14. The apparatus of claim 11 further comprising at least one speaker, and wherein the processing device is further caused to:
calculate a record score associated with the record based on the possible positions of the first word and the second word; and
play an audio/visual program associated with the record as a result of the record having the highest record score of all of the records of the plurality of records.

15. The apparatus of claim 11 further comprising a communications interface, and wherein the processing device is further caused to operate the communications interface to receive the ambiguous keypress sequence from a remote device having a reduced keyboard by which the ambiguous keypress sequence is created from the entry of the character string by the user.

16. The apparatus of claim 15 further comprising the remote device wherein the remote device is a remote control.

17. The apparatus of claim 11 further comprising a reduced keyboard, and wherein the ambiguous keypress sequence is created from the entry of the character string by the user.

18. The apparatus of claim 11 further comprising a touchscreen display capable of displaying a reduced keyboard, and wherein the ambiguous keypress sequence is created from the entry of the character string by the user by pressing the keys of the reduced keyboard displayed on the touchscreen display.

19. The apparatus of claim 11 further comprising a communications interface, and wherein the processing device is further caused to operate the communications interface to request the plurality of records from a media server, and wherein the processing device is further caused to operate the communications interface to request a copy of an audio/visual program associated with the record from the media server.

20. The apparatus of claim 11 further comprising a communications interface, and wherein the processing device is further caused to operate the communications interface to request the plurality of records from a media server, and wherein the processing device is further caused to operate the communications interface to request the media server to transmit a copy of an audio/visual program associated with the record from the media server to a media player.
